(19) United States
(12) Patent Application Publication
(10) Pub. No.: US 2026/0287986 A1
(43) Pub. Date: Sep. 24, 2026

(54) ACTUATOR DEVICE AND PROJECTION DEVICE

(71) Applicant: Coretronic Corporation, Hsin-Chu (TW)

(72) Inventors: Wei-Hao Chen, Hsin-Chu (TW); Keng-Chia Chang, Hsin-Chu (TW); Ken-Teng Peng, Hsin-Chu (TW)

(73) Assignee: Coretronic Corporation, Hsin-Chu (TW)

(21) Appl. No.: 19/561,527

(22) Filed: Mar. 10, 2026

(30) Foreign Application Priority Data
Mar. 18, 2025 (CN) 202510317736.X

(51) Int. Cl. G03B 21/14; G02B 7/02

(52) U.S. Cl. CPC G03B 21/14; G02B 7/02

(57) ABSTRACT

An actuator device includes a base, a frame, an optical element, at least two driving components, and a controller. Two central axes of the optical element are parallel to a first direction and a second direction. The at least two driving components are configured to drive the frame and the optical element to swing with respect to the base with the two central axes as rotation axes. The controller is electrically connected to the at least two driving components and configured to drive the at least two driving components to make the optical element swing according to a swing mode. The swing mode at least includes swinging of the optical element, so that an image beam from the optical element displaces toward a third direction. A vector of the third direction is a difference between a vector of the first direction and a vector of the second direction.

### CROSS-REFERENCE TO RELATED APPLICATION

This application claims the priority benefit of China application serial no. 202510317736.X, filed on Mar 18, 2025. The entirety of the above-mentioned patent application is hereby incorporated by reference herein and made a part of this specification.

### BACKGROUND

### Technical Field

The disclosure relates to an actuator device and a projection device.

### Related Art

As the demand of consumers for high-resolution projectors gradually increases, in order to improve the resolution of projectors, an actuator may be installed inside the projector. When the driving element of the actuator is in operation, the optical element rapidly swings back and forth, refracting (or reflecting) the image beam through the optical element to another position, achieving pixel displacement and thereby increasing the resolution.

In current projectors, if an imaging element with multiple rhombus micromirrors arranged is adopted, the actuator needs to be placed at a 45° rotation to make the image pixels move along a rhombus path. However, the overall contour of the imaging element with respect to the 45° rotated actuator remains rectangular. Therefore, when the actuator is placed with a 45° rotation, in order to allow the image beam from the imaging element to be transmitted to the optical element, the dimension of the optical element needs to be increased to meet the requirements.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an actuator device and a projection device, which can still increase resolution without the need to increase the dimension of the projection device/actuator device.

To achieve one or part or all of the above purposes or other purposes, an embodiment of the disclosure provides an actuator device, which includes a base, a frame, an optical element, at least two driving components, and a controller. The frame is disposed in the base. The optical element is disposed in the frame. Two central axes of the optical element are parallel to a first direction and a second direction. The at least two driving components are disposed between the base and the frame corresponding to the two central axes of the optical element. The at least two driving components are configured to drive the frame and the optical element to swing with respect to the base with the two central axes as rotation axes. The controller is electrically connected to the at least two driving components and configured to drive the at least two driving components to make the optical element swing according to a swing mode. The swing mode at least includes swinging of the optical element with respect to the base, so that an image beam from the optical element displaces toward a third direction. A vector of the third direction is a difference between a vector of the first direction and a vector of the second direction.

In an embodiment of the disclosure, the swing mode includes at least one of a first swing mode, a second swing mode, and a third swing mode. The first swing mode further includes making the image beam from swinging of the optical element to displace toward a direction opposite to the third direction, a fourth direction, and an opposite direction thereof. The second swing mode further includes making the image beam from the optical element to displace toward the second direction and a direction opposite to the first direction. The third swing mode further includes making the image beam from the optical element to displace toward a direction opposite to the third direction, the second direction, and an opposite direction thereof. A vector of the fourth direction is the sum of the vector of the first direction and the vector of the second direction.

In an embodiment of the disclosure, the at least two driving components include at least one first driving component and at least one second driving component. The two central axes of the optical element include a first axis parallel to the second direction and a second axis parallel to the first direction. The at least one first driving component is configured to make the optical element swing back and forth with respect to the base with the first axis as the rotation axis. The at least one second driving component is configured to make the optical element swing back and forth with respect to the base with the second axis as the rotation axis.

In an embodiment of the disclosure, the controller is configured to drive the at least two driving components by multiple driving signals. The multiple driving signals include a first driving signal configured to drive the at least one first driving component and a second driving signal configured to drive the at least one second driving component. In each phase of each cycle, one of the first driving signal and the second driving signal is a zero signal, while the other is a positive signal or a negative signal.

In an embodiment of the disclosure, each cycle of the swing mode sequentially includes a first phase, a second phase, a third phase, and a fourth phase. The swing mode includes making the image beam from the optical element to displace toward the third direction, the fourth direction, a direction opposite to the third direction, and a direction opposite to the fourth direction in the first to fourth phases respectively. A vector of the fourth direction is the sum of the vector of the first direction and the vector of the second direction.

In an embodiment of the disclosure, the first driving signal in the first to fourth phases is sequentially a zero signal, a positive signal, a zero signal, and a negative signal. The second driving signal in the first to fourth phases is sequentially a positive signal, a zero signal, a negative signal, and a zero signal.

In an embodiment of the disclosure, each cycle of the swing mode sequentially includes a first phase, a second phase, a third phase, and a fourth phase. The swing mode includes making the image beam from the optical element to displace toward the third direction, the second direction, the third direction, and a direction opposite to the first direction in the first to fourth phases respectively.

In an embodiment of the disclosure, the first driving signal in the first to fourth phases is sequentially a zero signal, a zero signal, a positive signal, and a negative signal. The second driving signal in the first to fourth phases is sequentially a positive signal, a negative signal, a zero signal, and a zero signal.

In an embodiment of the disclosure, each cycle of the swing mode sequentially includes a first phase, a second phase, a third phase, a fourth phase, a fifth phase, a sixth phase, a seventh phase, and an eighth phase. The swing mode includes making the image beam from the optical element to displace toward the third direction, the second direction, the third direction, a direction opposite to the third direction, a direction opposite to the second direction, and a direction opposite to the third direction in the second to fourth and the sixth to eighth phases respectively.

In an embodiment of the disclosure, the first driving signal in the first to eighth phases is a negative signal, a zero signal, a zero signal, a positive signal, a positive signal, a zero signal, a zero signal, and a negative signal. The second driving signal in the first to eighth phases is a zero signal, a positive signal, a negative signal, a zero signal, a zero signal, a negative signal, a positive signal, and a zero signal.

To achieve one or part or all of the above purposes or other purposes, an embodiment of the disclosure provides a projection device, which includes an illumination system, a light valve, a projection lens, and the actuator device. The illumination system is configured to provide an illumination beam. The light valve is located on a transmission path of the illumination beam. The light valve has an effective area. The effective area is configured to receive the illumination beam and is configured to convert the illumination beam into an image beam. The light valve includes a plurality of micromirrors located on the effective area, in which two central axes of the effective area are parallel to the first direction and the second direction. The projection lens is located on the transmission path of the image beam and is configured to project the image beam out of the projection device.

Based on the above, in an embodiment of the actuator device and the projection device of the disclosure, two central axes of the optical element are parallel to the first direction and the second direction, and the controller is configured to drive the driving component to make the optical element swing according to the swing mode. In the embodiments, the swing direction of the swing mode at least includes swinging of the optical element toward the third direction with respect to the base to make each pixel of the image beam operate in a rhombus path or to make the pixel displacement contour formed by multiple pixel displacement positions a rhombus. Therefore, the actuator device can still increase resolution without the need to increase the dimension of the projection device/actuator device.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a schematic diagram of a projection device according to an embodiment of the disclosure.

FIG. 1B is a schematic diagram of a projection device according to another embodiment of the disclosure.

FIG. 2 is a schematic diagram of a light valve of the projection device according to an embodiment of the disclosure.

FIG. 3A is a schematic diagram of an actuator device according to an embodiment of the disclosure.

FIG. 3B is a schematic diagram of the actuator device according to another embodiment of the disclosure.

FIG. 4A is a schematic diagram of pixel displacement generated by swinging and corresponding driving signals thereof in a first swing mode of the actuator device according to an embodiment of the disclosure.

FIG. 4B is a schematic diagram of the driving signals in FIG. 4A further including oscillating signals.

FIG. 5 is a schematic diagram of pixel displacement generated by swinging and corresponding driving signals thereof in a second swing mode of the actuator device according to an embodiment of the disclosure.

FIG. 6 is a schematic diagram of pixel displacement generated by swinging and corresponding driving signals thereof in a third swing mode of the actuator device according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

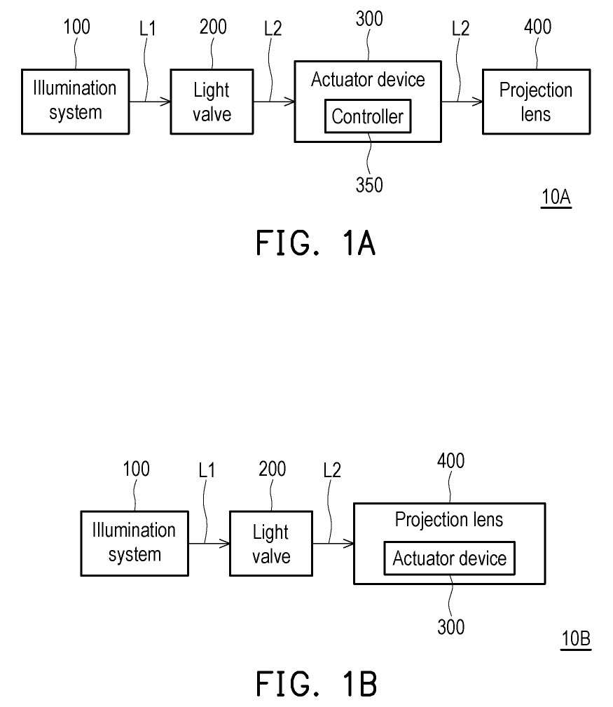

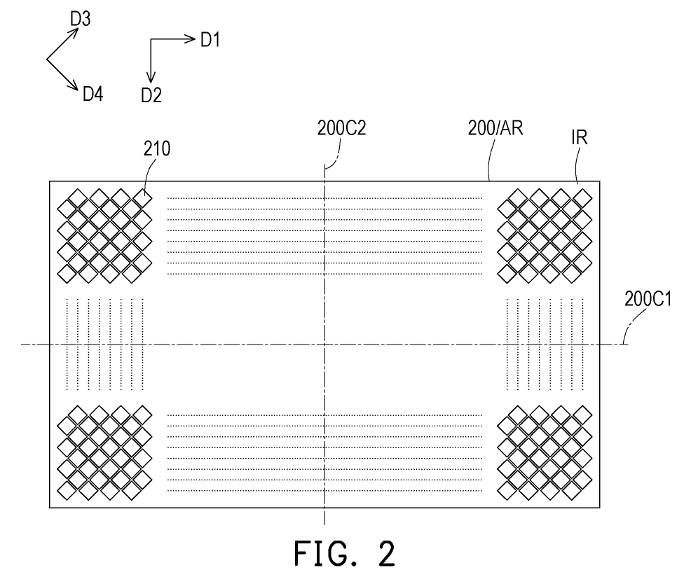

FIG. 1A is a schematic diagram of a projection device according to an embodiment of the disclosure. FIG. 1B is a schematic diagram of a projection device according to another embodiment of the disclosure. FIG. 2 is a schematic diagram of a light valve of the projection device according to an embodiment of the disclosure.

Referring to FIGS. 1A to 2, an embodiment of the disclosure provides projection devices 10A, 10B, and each of the projection devices includes an illumination system 100, a light valve 200, a projection lens 400, and an actuator device 300. The illumination system 100 is configured to provide an illumination beam L1. The light valve 200 is located on the transmission path of the illumination beam L1. The light valve 200 is, for example, a Digital Micro-mirror Device (DMD). The light valve 200 has an effective area AR. The effective area AR is configured to receive the illumination beam L1 from the illumination system 100, and is configured to convert the illumination beam L1 into an image beam L2. The light valve 200 includes a plurality of micromirrors 210 located on the effective area AR, in which two central axes 200C1, 200C2 of the effective area AR are parallel to a first direction D1 and a second direction D2. The central axes 200C1, 200C2 are lines connecting midpoints of any two adjacent edges of the effective area AR with midpoints of respective opposite edges thereof. The projection lens 400 is located on the transmission path of the image beam L2, and is configured to project the image beam L2 out of the projection devices 10A, 10B. The actuator device 300 is located on the transmission path of the image beam L2 from the light valve 200 and is disposed between the light valve 200 and the projection lens 400 (as shown in FIG. 1A) or disposed within the projection lens 400 (as shown in FIG. 1B). In other embodiments, the actuator device 300 may also be disposed between a prism (not shown) of the projection device 10A and the projection lens 400.

In detail, in this embodiment, the illumination system 100 may be formed by components such as a light source, a wavelength conversion element (for example, a phosphor wheel), a homogenizing element (for example, an integration rod), a filtering element (for example, a filter wheel), a light guiding element (for example, a mirror), or the illumination system 100 may be formed by components such as a multi-color light source, a light combining element (for example, a mirror and/or a lens element), a light splitting element (for example, a beam splitter), to provide light beams of different wavelengths as the source of the illumination beam L1. The light source may include one or more light emitting elements, in which the light emitting elements are, for example, Light Emitting Diodes (LED) and/or Laser Diodes (LD).

In this embodiment, the projection lens 400 is, for example, a combination of one or more optical lenses with refractive power. The embodiments of the disclosure do not limit the type or kind of the projection lens 400.

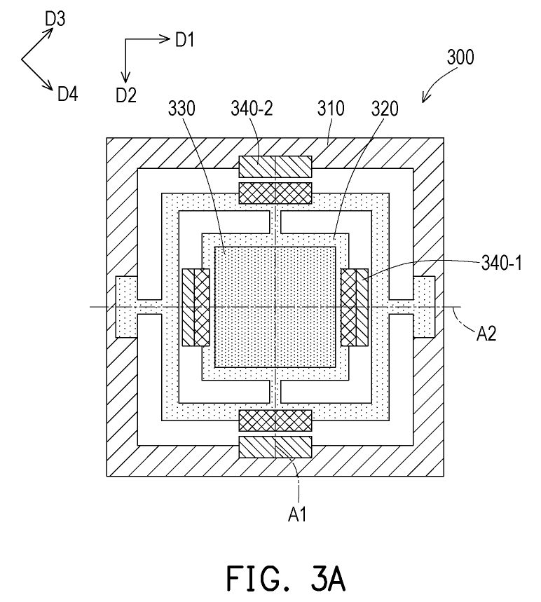

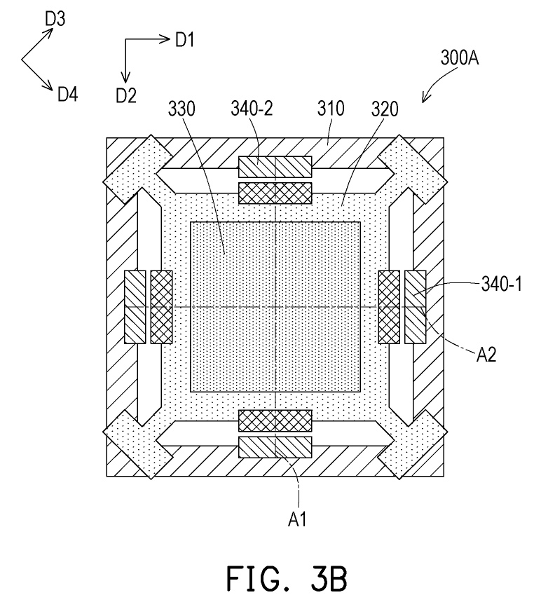

Referring to FIGS. 1A, 1B, and 3A, in this embodiment, the actuator device 300 includes a base 310, a frame 320, an optical element 330, at least two driving components, and a controller 350. The at least two driving components include at least one first driving component 340-1 and at least one second driving component 340-2. The frame 320 is disposed in the base 310. The optical element 330 is disposed in the frame 320. The at least two driving components 340-1, 340-2 are disposed between the base 310 and the frame 320. The at least two driving components 340-1, 340-2 are configured to drive the frame 320 and the optical element 330 to swing with respect to the base 310 with two central axes A1, A2 as rotation axes. That is, with the base 310 as a fixed reference point, the frame 320 and the optical element 330 swing with respect to the base 310.

FIG. 3A is a schematic diagram of an actuator device according to an embodiment of the disclosure. FIG. 3B is a schematic diagram of the actuator device according to another embodiment of the disclosure. In this embodiment, the actuator device 300 in FIGS. 1A and 1B may be respectively implemented as the dual-axis drive actuator device 300 with inner and outer frame type shown in FIG. 3A or a dual-axis drive actuator device 300A with suspension type shown in FIG. 3B. In the embodiment shown in FIG. 3A, the frame 320 includes an inner frame (not indicated) and an outer frame (not indicated). The outer frame may be disposed in the base 310, and may be connected to the base 310 by a rotation axis (not indicated). The inner frame may be disposed in the outer frame, and may be connected to the outer frame by a rotation axis (not indicated). The optical element 330 may be disposed in the inner frame. The at least one first driving component 340-1 is disposed between the outer frame and the inner frame, and the at least one second driving component 340-2 is disposed between the base 310 and the outer frame. In the embodiment shown in FIG. 3B, the frame 320 may be connected to the base 310 by a rotation axis (not indicated), and the at least one first driving component 340-1 and the at least one second driving component 340-2 are respectively located between the base 310 and the frame 320.

The actuator device 300 and the actuator device 300A may be in the form of dual-side drive or single-side drive respectively. The aforementioned dual-side drive means that the first driving component 340-1 includes at least two components, and the second driving component 340-2 includes at least two components. As shown in FIGS. 3A and 3B, the actuator device 300 and the actuator device 300A each include two sets of the first driving components 340-1 and two sets of the second driving components 340-2. The two central axes of the optical element 330 include a first axis A1 and a second axis A2, the first axis A1 is parallel to the second direction D2, and the second axis A2 is parallel to the first direction D1. The first direction D1 may be perpendicular to the second direction D2. The central axis is the line connecting the midpoints of any two adjacent edges of the optical element 330 with the midpoints of respective opposite edges thereof. The two sets of first driving components 340-1 correspond to the second axis A2 and are disposed on opposite sides of the frame 320, while the two sets of second driving components 340-2 correspond to the first axis A1, and are disposed on opposite sides of the frame 320.

In other embodiments, the actuator device 300 and the actuator device 300A may also be in the form of single-side drive. The aforementioned single-side drive means that the first driving component 340-1 is a single component, and the second driving component 340-2 is a single component, one set of first driving component 340-1 corresponds to the second axis A2, and one set of second driving component 340-2 corresponds to the first axis A1.

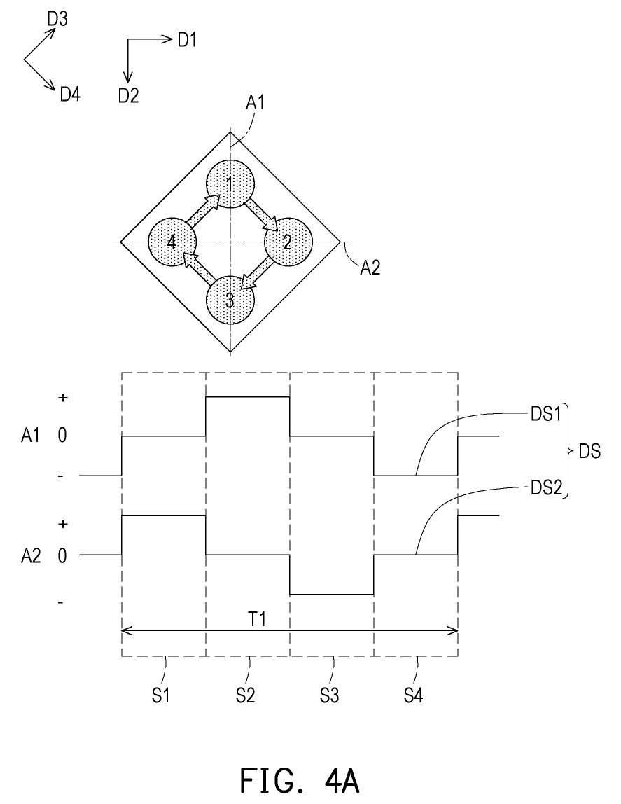

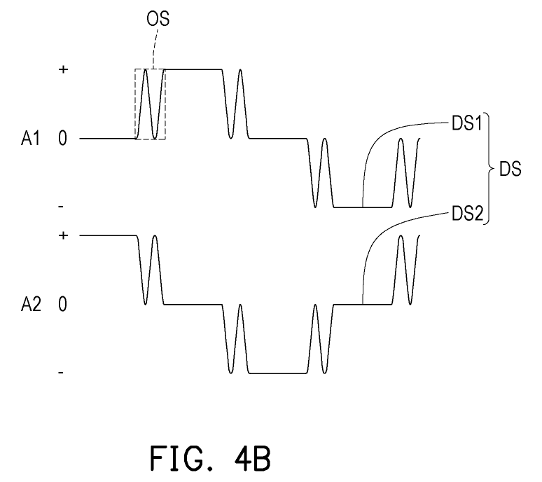

In this embodiment, the optical element 330 may be glass, plastic, or other light-transmitting elements with a refractive index greater than 1, or may be a reflective element (such as a mirror). The optical element 330 is configured to receive the image beam L2 from the light valve 200, and allow the image beam L2 to pass through or be reflected. In this way, when the optical element 330 swings with the frame 320, compared to the state where the optical element 330 is not swinging, the image beam L2 incident on the optical element 330 is displaced in the transmission path thereof due to refraction or reflection, so as to adjust the projection position of the image beam L2, such as positions 1, 2, 3, 4 shown in FIGS. 4A, 5, and 6. The contour range of the optical element 330 in FIGS. 3A and 3B includes at least the optical effective range, where the optical effective range is the range where the image beam L2 from the effective area AR of the light valve 200 is transmitted to the optical element 330. The optical effective range of the optical element 330 may be the rectangle shown in FIGS. 3A and 3B. When the optical element 330 is in a non-swinging state, the four edges of the contour of the optical element 330 may be parallel to the four edges of the contour of the effective area AR of the light valve 200. In other embodiments, the optical element 330 may also be of other shapes.

In this embodiment, the controller 350 is electrically connected to the at least two driving components 340-1, 340-2 and configured to drive the at least two driving components 340-1, 340-2 to make the optical element 330 swing. The at least two driving components 340-1, 340-2 are, for example, voice coil motors, piezoelectric materials, or electromagnets. The controller 350 is, for example, a central processing unit (CPU), a microprocessor, a digital signal processor (DSP), a programmable controller, a programmable logic device (PLD), or other similar devices, or a combination of the devices. In one embodiment, the various functions of the controller 350 may be implemented as multiple program codes. The program codes are stored in a memory unit, executed by the controller 350. Alternatively, in one embodiment, the various functions of the controller 350 may be implemented as one or more circuits. The embodiments of the disclosure do not limit the implementation of the various functions of the controller 350 to software or hardware methods.

In this embodiment, the controller 350 is configured to drive the first driving component 340-1 and the second driving component 340-2 to make the optical element 330 swing according to the swing mode. The first driving component 340-1 is configured to make the optical element 330 swing back and forth with respect to the base 310 with the first axis A1 as the rotation axis. The second driving component 340-2 is configured to make the optical element 330 swing back and forth with respect to the base 310 with the second axis A2 as the rotation axis.

In this embodiment, as shown in FIG. 2, when multiple edges of the contour of the micromirror 210 of the light valve 200 are not parallel to the long or short edges of the effective area AR of the light valve 200, then the controller 350 is configured to control the swing mode at least includes swinging of the optical element 330 with respect to the base 310, so that the image beam L2 from the optical element 330 displaces toward the third direction D3, so that the pixel displacement path of the image beam L2 or the pixel displacement contour formed by multiple pixel displacement positions may correspond to the (contour of) micromirror 210. The vector of the third direction D3 is the difference between the vector of the first direction D1 and the vector of the second direction D2. The third direction D3 is not parallel to either the first direction D1 or the first direction D2.

For example, as shown in FIG. 2, the contour of the effective area AR of the light valve 200 is rectangular. When the contour of the micromirror 210 of the light valve 200 is a rhombus with respect to the effective area AR, or when any rotation axis (not shown) on the micromirror 210 of the light valve 200 is parallel to the long or short edges of the effective area AR of the light valve 200, then the controller 350 is configured to make each pixel of the image beam L2 move in a rhombus path (or to make the pixel displacement contour formed by multiple pixel displacement positions a rhombus). Thereby, the pixel displacement path (or the pixel displacement contour) of the image beam L2 is parallel to the contour (rhombus) of the micromirror 210 of the light valve 200. In this embodiment, the two diagonals of each micromirror 210 are parallel to the first direction D1 and the second direction D2, and two adjacent edges of the micromirror 210 are parallel to the third direction D3 and the fourth direction D4.

In this embodiment, the controller 350 is configured to generate multiple driving signals DS to the at least two driving components 340-1, 340-2 to drive the at least two driving components 340-1, 340-2. In the same timing sequence, the multiple driving signals DS may respectively correspond to different driving currents and/or different driving voltages. The multiple driving signals DS include a first driving signal DS1 configured to drive the first driving component 340-1 and a second driving signal DS2 configured to drive the second driving component 340-2. In each phase of each cycle T1, one of the first driving signal DS1 and the second driving signal DS2 is a zero signal (that is, the driving current or driving voltage is 0), and the other is a positive signal or a negative signal. That is, when the at least two driving components 340-1, 340-2 are in operation, in each phase, either the first driving signal DS1 or the second driving signal DS2 is a zero signal, and the first driving signal DS1 and the second driving signal DS2 are not both zero signals at the same time. Also, in some embodiments, the first driving component 340-1 and the second driving component 340-2 are in operation synchronously, with no phase difference between the first driving signal DS1 and the second driving signal DS2.

In this embodiment, the swing mode of the optical element 330 may include at least one of a first swing mode, a second swing mode, and a third swing mode. The actuator devices 300 and 300A may have only one swing mode or have multiple swing modes. The first swing mode, the second swing mode, and the third swing mode will be described sequentially below.

FIG. 4A is a schematic diagram of pixel displacement generated by swinging and corresponding driving signals thereof in a first swing mode of the actuator device according to an embodiment of the disclosure. Referring to FIG. 4A, the swing directions of the first swing mode include not only swinging of the optical element 330 with respect to the base 310, to let the image beam L2 from the optical element 330 to displace toward the third direction D3 (for example, the upper right direction), but also displace toward the direction opposite to the third direction D3 (for example, the lower left direction), the fourth direction D4 (for example, the lower right direction), and an opposite direction thereof (for example, the upper left direction). The vector of the fourth direction D4 is the sum of the vector of the first direction D1 and the vector of the second direction D2. The fourth direction D4 is not parallel to either the first direction D1 or the first direction D2. In the embodiment where the contour of the micromirror 210 of the light valve 200 is a rhombus with respect to the effective area AR, the third direction D3 may be perpendicular to the fourth direction D4.

In this embodiment, each cycle T1 of the first swing mode sequentially includes a first phase S1, a second phase S2, a third phase S3, and a fourth phase S4. The first swing mode includes swinging of the optical element 330 with respect to the base 310, so that the image beam L2 from the optical element 330 displaces toward the third direction D3, the fourth direction D4, the direction opposite to the third direction D3, and the direction opposite to the fourth direction D4in the first to fourth phases S1 to S4 respectively.

In this embodiment, the first driving signal DS1 in the first to fourth phases S1 to S4 is sequentially a zero signal, a positive signal, a zero signal, and a negative signal. The second driving signal DS2 in the first to fourth phases S1 to S4 is sequentially a positive signal, a zero signal, a negative signal, and a zero signal.

Taking the cycle T1 in the lower section of FIG. 4A as an example, the image beam L2 from the optical element 330 may form a light spot moving in a sequence from the position 1 to the position 4 on a virtual plane, thereby performing pixel displacement. The virtual plane is, for example, parallel to the projection surface. For example, taking the optical element 330 as a light-transmitting element as an example, taking the position 4 as a starting point, at the beginning of the first phase S1, the first driving signal DS1 changes from a negative signal to a zero signal, the second driving signal DS2 changes from a zero signal to a positive signal, the optical element 330 swings with respect to the base 310, and the position where the image beam L2 passes through the optical element 330 moves from the position 4 to the position 1 (displace toward the third direction D3). At the beginning of the second phase S2, the first driving signal DS1 changes from a zero signal to a positive signal, the second driving signal DS2 changes from a positive signal to a zero signal, the optical element 330 swings with respect to the base 310, and the position where the image beam L2 passes through the optical element 330 moves from the position 1 to the position 2 (displace toward the fourth direction D4). At the beginning of the third phase S3, the first driving signal DS1 changes from a positive signal to a zero signal, the second driving signal DS2 changes from a zero signal to a negative signal, the optical element 330 swings with respect to the base 310, and the position where the image beam L2 passes through the optical element 330 moves from the position 2 to the position 3 (displace toward the direction opposite to the third direction D3). At the beginning of the fourth phase S4, the first driving signal DS1 changes from a zero signal to a negative signal, the second driving signal DS2 changes from a negative signal to a zero signal, the optical element 330 swings with respect to the base 310, and the position where the image beam L2 passes through the optical element 330 moves from the position 3 to the position 4 (displace toward the direction opposite to the fourth direction D4). The first swing mode, for example, corresponds to making the pixel displacement path of the image beam L2 move in a clockwise (or counterclockwise) rhombus path. Therefore, in one cycle T1, the image beam L2 forms a pixel collection at the positions 1 to 4, and the pixel displacement contour formed by the multiple pixel displacement positions (the positions 1 to 4) is a rhombus. Through the displacement of the position of each pixel of the image, the resolution of the projection devices 10A, 10B is enhanced. The above description takes the optical element 330 as a light-transmitting element as an example. In other embodiments, when the optical element 330 is a reflective element, then the image beam L2 is reflected by the optical element 330 to change the position thereof. Moreover, in other embodiments, in the first to fourth phases S1 to S4, the pixel displacement position of the image beam L2 may also be moved counterclockwise from the position 1 to the position 4, the position 3, and the position 2.

FIG. 4B is a schematic diagram of the driving signals in FIG. 4A further including oscillating signals. Referring to FIGS. 4A and 4B, the first driving signal DS1 and the second driving signal DS2 further include oscillating signals OS respectively to make the optical element 330 swing. The oscillating signal OS acts during the swing period (also corresponding to the beginning of the phase, between signal transitions) of the optical element 330, and the optical element 330 stays at a steady-state position (corresponding to the stable state of the first driving signal DS1/second driving signal DS2) after swinging. For example, at the beginning of the first phase S1, the oscillating signals OS of the first driving signal DS1 and the second driving signal DS make the image beam L2 displace toward the third direction D3, and the position of the image beam L2 stays at the position 1 after the optical element 330 swinging.

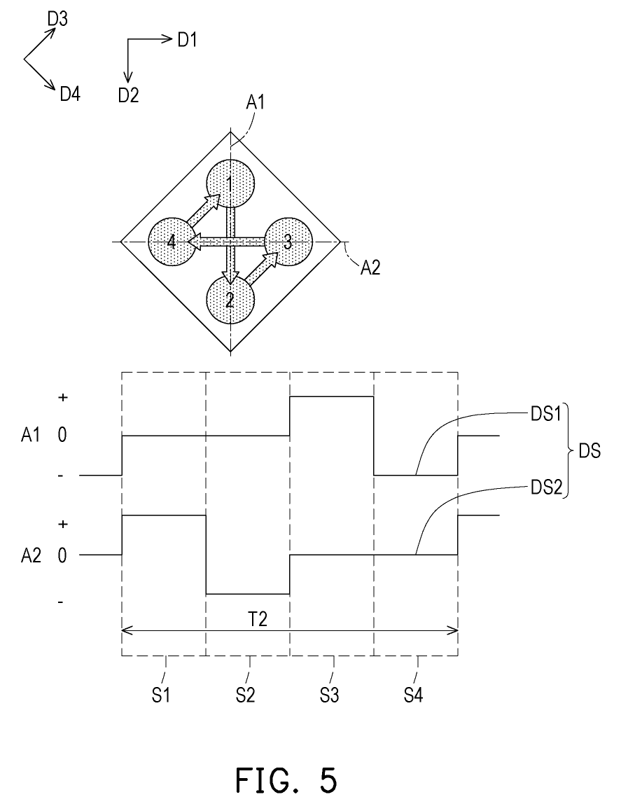

FIG. 5 is a schematic diagram of pixel displacement generation and corresponding driving signals thereof in a second swing mode of the actuator device according to an embodiment of the disclosure. Referring to FIG. 5, in this embodiment, the second swing mode further includes making the image beam L2 from the optical element 330 to displace toward the second direction D2 and the opposite direction of the first direction D1.

In this embodiment, each cycle T2 of the second swing mode sequentially includes a first phase S1, a second phase S2, a third phase S3, and a fourth phase S4. The second swing mode includes swinging of the optical element 330 with respect to the base 310, so that the image beam L2 from the optical element 330 displaces toward the third direction D3, the second direction D2, the third direction D3, and the opposite direction of the first direction D1 in the first to fourth phases S1 to S4 respectively.

In this embodiment, the first driving signal DS1 in the first to fourth phases S1 to S4 is sequentially a zero signal, a zero signal, a positive signal, and a negative signal. The second driving signal DS2 in the first to fourth phases S1 to S4 is sequentially a positive signal, a negative signal, a zero signal, and a zero signal.

Taking the cycle T2 in the lower section of FIG. 5 as an example, the image beam L2 from the optical element 330 may form a light spot moving in a sequence from the position 1 to the position 4 on a virtual plane, thereby performing pixel displacement. For example, taking the optical element 330 as a light-transmitting element as an example, taking the position 4 as a starting point, at the beginning of the first phase S1, the first driving signal DS1 changes from a negative signal to a zero signal, and the second driving signal DS2 changes from a zero signal to a positive signal, the optical element 330 swings with respect to the base 310, and the position where the image beam L2 passes through the optical element 330 moves from the position 4 to the position 1 (displace toward the third direction D3). At the beginning of the second phase S2, the first driving signal DS1 maintains as a zero signal, the second driving signal DS2 changes from a positive signal to a negative signal, the optical element 330 swings with respect to the base 310, and the position where the image beam L2 passes through the optical element 330 moves from the position 1 to the position 2 (displace toward the second direction D2). At the beginning of the third phase S3, the first driving signal DS1 changes from a zero signal to a positive signal, the second driving signal DS2 changes from a negative signal to a zero signal, the optical element 330 swings with respect to the base 310, and the position where the image beam L2 passes through the optical element 330 moves from the position 2 to the position 3 (displace toward the third direction D3). At the beginning of the fourth phase S4, the first driving signal DS1 changes from a positive signal to a negative signal, the second driving signal DS2 maintains as a zero signal, the optical element 330 swings with respect to the base 310, and the position where the image beam L2 passes through the optical element 330 moves from the position 3 to the position 4 (displace toward the opposite direction of the first direction D1). The second swing mode, for example, corresponds to making the pixel displacement path of the image beam L2 include at least diagonal path movement, such as moving from the position 1 to the position 2, which is the diagonal position thereof, moving from the position 3 the position 4, which is the diagonal position thereof. Therefore, the image beam L2 forms a pixel collection of the projection devices 10A, 10B at the positions 1 to 4, and the pixel displacement contour formed by the multiple pixel displacement positions (the positions 1 to 4) is a rhombus, which improves the image resolution of the projection devices 10A, 10B.

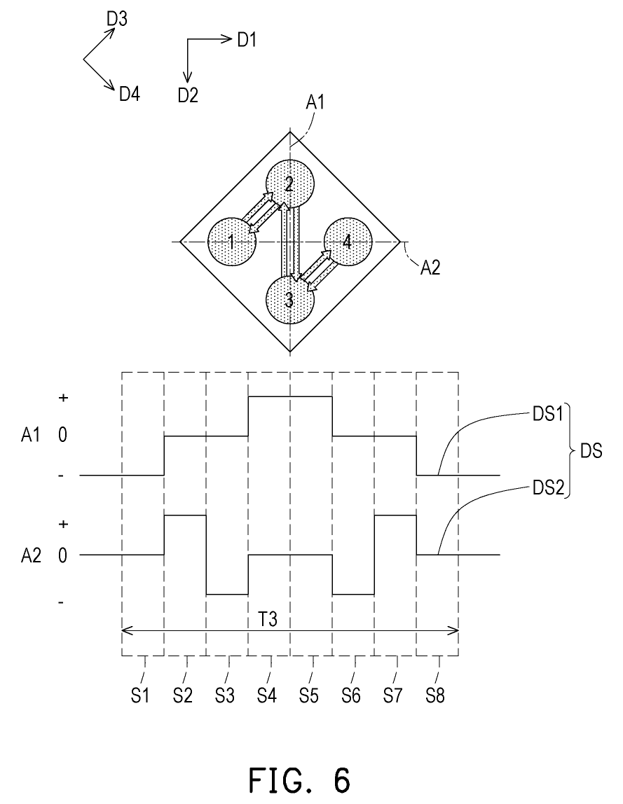

FIG. 6 is a schematic diagram of pixel displacement generation and corresponding driving signals thereof in a third swing mode of the actuator device according to an embodiment of the disclosure. Referring to FIG. 6, in this embodiment, the third swing mode further includes making the image beam L2 from the optical element 330 to displace toward the opposite direction of the third direction D3, the second direction D2, and the opposite direction thereof.

In this embodiment, each cycle T3 of the third swing mode sequentially includes a first phase S1, a second phase S2, a third phase S3, a fourth phase S4, a fifth phase S5, a sixth phase S6, a seventh phase S7, and an eighth phase S8. The third swing mode includes swinging of the optical element 330 with respect to the base 310, so that the image beam L2 from the optical element 330 displaces toward the third direction D3, the second direction D2, the third direction D3, the opposite direction of the third direction D3, the opposite direction of the second direction D2, and the opposite direction of the third direction D3 in the second to fourth and the sixth to eighth phases S2 to S4 and S6 to S8 respectively.

In this embodiment, the first driving signal DS1 in the first to eighth phases S1 to S8 is a negative signal, a zero signal, a zero signal, a positive signal, a positive signal, a zero signal, a zero signal, and a negative signal. The second driving signal DS2 in the first to eighth phases S1 to S8 is a zero signal, a positive signal, a negative signal, a zero signal, a zero signal, a negative signal, a positive signal, and a zero signal.

Taking the cycle T3 in the lower section of FIG. 6 as an example, the image beam L2 from the optical element 330 may form a light spot moving in a sequence from the position 1 to the position 4 on a virtual plane, thereby performing pixel displacement. For example, taking the optical element 330 as a light-transmitting element as an example, taking the position 1 as a starting point, at the first phase S1, the first driving signal DS1 maintains as a negative signal, the second driving signal DS2 maintains as a zero signal, and the position where the image beam L2 passes through the optical element 330 remains at the position 1 of the eighth phase S8, that is, remains fixed at the position 1. At the beginning of the second phase S2, the first driving signal DS1 changes from a negative signal to a zero signal, the second driving signal DS2 changes from a zero signal to a positive signal, the optical element 330 swings with respect to the base 310, and the position where the image beam L2 passes through the optical element 330 moves from the position 1 to the position 2 (displace toward the third direction D3). At the beginning of the third phase S3, the first driving signal DS1 maintains as a zero signal, the second driving signal DS2 changes from a positive signal to a negative signal, the optical element 330 swings with respect to the base 310, and the position where the image beam L2 passes through the optical element 330 moves from the position 2 to the position 3 (displace toward the second direction D2). At the beginning of the fourth phase S4, the first driving signal DS1 changes from a zero signal to a positive signal, the second driving signal DS2 changes from a negative signal to a zero signal, the optical element 330 swings with respect to the base 310, and the position where the image beam L2 passes through the optical element 330 moves from the position 3 to the position 4 (displace toward the third direction D3). At the fifth phase S5, the first driving signal DS1 maintains as a positive signal, the second driving signal DS2 maintains as a zero signal, and the position where the image beam L2 passes through the optical element 330 remains at the position 4 of the fourth phase S4, that is, remains fixed at the position 4. At the beginning of the sixth phase S6, the first driving signal DS1 changes from a positive signal to a zero signal, the second driving signal DS2 changes from a zero signal to a negative signal, the optical element 330 swings with respect to the base 310, and the position where the image beam L2 passes through the optical element 330 moves from the position 4 to the position 3 (displace toward the opposite direction of the third direction D3). At the beginning of the seventh phase S7, the first driving signal DS1 maintains as a zero signal, the second driving signal DS2 changes from a negative signal to a positive signal, the optical element 330 swings with respect to the base 310, and the position where the image beam L2 passes through the optical element 330 moves from the position 3 to the position 2 (displace toward the opposite direction of the second direction D2). At the beginning of the eighth phase S8, the first driving signal DS1 changes from a zero signal to a negative signal, the second driving signal DS2 changes from a positive signal to a zero signal, the optical element 330 swings with respect to the base 310, and the position where the image beam L2 passes through the optical element 330 moves from the position 2 to the position 1 (displace toward the opposite direction of the third direction D3). The third swing mode, for example, corresponds to making the pixel displacement path of the image beam L2 move back along the original path. The first driving signal DS1 is mirror-symmetrical in the first to fourth phases S1 to S4 and the fifth to eighth phases S5 to S8; the second driving signal DS2 is mirror-symmetrical in the first to fourth phases S1 to S4 and the fifth to eighth phases S5 to S8. Therefore, the image beam L2 forms a pixel collection of the projection devices 10A, 10B at the positions 1 to 4, and then at the positions 4 to 1, and the pixel displacement contour formed by the multiple pixel displacement positions (the positions 1 to 4) is a rhombus, which increases the image resolution of the projection devices 10A, 10B.

In this embodiment, through the first swing mode, the second swing mode, and/or the third swing mode of the optical element 330, the pixel displacement contour (rhombus) formed by the multiple pixel displacement positions (the positions 1 to 4) of the image beam L2 may correspond to the contour (rhombus) of the micromirror 210 of the light valve 200. Based on above, compared with the projectors in related art, the actuator devices 300 and 300A of the embodiments of the disclosure do not need to be placed at a 45° rotation with respect to the effective area AR of the light valve, and can still meet the requirement that the pixel displacement contour is a rhombus. In this way, effects such as not needing to additionally increase the dimension of the actuator, improved space utilization rate, and enhanced image resolution can be achieved.

In summary, in an embodiment of the disclosure, the actuator device and the projection device using this actuator device include a base, a frame, an optical element, at least two driving components, and a controller. The optical element is disposed in the frame, and two central axes of the optical element are parallel to the first direction and the second direction. The driving components are configured to drive the frame and the optical element to swing with respect to the base with the two central axes as rotation axes. The controller is configured to drive the driving components to make the optical element swing according to the swing mode. In the embodiments, the swing mode at least includes swinging of the optical element with respect to the base to make each pixel of the image beam operate in a rhombus path or to make the pixel displacement contour formed by the multiple pixel displacement positions a rhombus. Therefore, the actuator device can still increase resolution without the need to increase the dimension of the projection device/actuator device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An actuator device comprising a base, a frame, an optical element, at least two driving components, and a controller, wherein
the frame is disposed in the base,
the optical element is disposed in the frame, and two central axes of the optical element are parallel to a first direction and a second direction,
the at least two driving components are disposed between the base and the frame corresponding to the two central axes of the optical element, and the at least two driving components are configured to drive the frame and the optical element to swing with respect to the base with the two central axes as rotation axes, and
the controller is electrically connected to the at least two driving components and configured to drive the at least two driving components to make the optical element swing according to a swing mode,
wherein the swing mode at least comprises swinging of the optical element with respect to the base, so that an image beam from the optical element displaces toward a third direction, and a vector of the third direction is a difference between a vector of the first direction and a vector of the second direction.

2. The actuator device as claimed in claim 1, wherein the swing mode comprises at least one of a first swing mode, a second swing mode, and a third swing mode, wherein the first swing mode further comprises making the image beam from the optical element to displace toward a direction opposite to the third direction, a fourth direction, and an opposite direction thereof, the second swing mode further comprises making the image beam from the optical element to displace toward the second direction and a direction opposite to the first direction, the third swing mode further comprises making the image beam from the optical element to displace toward the direction opposite to the third direction, the second direction, and an opposite direction thereof, and a vector of the fourth direction is a sum of the vector of the first direction and the vector of the second direction.

3. The actuator device as claimed in claim 1, wherein the at least two driving components comprise at least one first driving component and at least one second driving component, the two central axes of the optical element comprise a first axis parallel to the second direction and a second axis parallel to the first direction, wherein:
the at least one first driving component is configured to make the optical element swing back and forth with respect to the base with the first axis as a rotation axis, and
the at least one second driving component is configured to make the optical element swing back and forth with respect to the base with the second axis as a rotation axis.

4. The actuator device as claimed in claim 3, wherein the controller is configured to drive the at least two driving components by a plurality of driving signals,
wherein the plurality of driving signals comprise a first driving signal configured to drive the at least one first driving component and a second driving signal configured to drive the at least one second driving component,
wherein in each phase of each cycle, one of the first driving signal and the second driving signal is a zero signal, while the other is a positive signal or a negative signal.

5. The actuator device as claimed in claim 4, wherein each of the cycles of the swing mode sequentially comprises a first phase, a second phase, a third phase, and a fourth phase,
wherein the swing mode comprises making the image beam from the optical element to displace toward the third direction, a fourth direction, a direction opposite to the third direction, and a direction opposite to the fourth direction in the first phase to the fourth phase respectively, and a vector of the fourth direction is a sum of the vector of the first direction and the vector of the second direction.

6. The actuator device as claimed in claim 5, wherein the first driving signal in the first phase to the fourth phase is sequentially the zero signal, the positive signal, the zero signal, and the negative signal, and the second driving signal in the first phase to the fourth phase is sequentially the positive signal, the zero signal, the negative signal, and the zero signal.

7. The actuator device as claimed in claim 4, wherein each of the cycles of the swing mode sequentially comprises a first phase, a second phase, a third phase, and a fourth phase,
wherein the swing mode comprises making the image beam from the optical element to displace toward the third direction, the second direction, the third direction, and a direction opposite to the first direction in the first phase to the fourth phase respectively.

8. The actuator device as claimed in claim 7, wherein the first driving signal in the first phase to the fourth phase is sequentially the zero signal, the zero signal, the positive signal, and the negative signal, and the second driving signal in the first phase to the fourth phase is sequentially the positive signal, the negative signal, the zero signal, and the zero signal.

9. The actuator device as claimed in claim 4, wherein each of the cycles of the swing mode sequentially comprises a first phase, a second phase, a third phase, a fourth phase, a fifth phase, a sixth phase, a seventh phase, and an eighth phase,
wherein the swing mode comprises making the image beam from the optical element to displace toward the third direction, the second direction, the third direction, a direction opposite to the third direction, a direction opposite to the second direction, and the direction opposite to the third direction in the second phase to the fourth phase and the sixth phase to the eighth phase respectively.

10. The actuator device as claimed in claim 9, wherein the first driving signal in the first phase to the eighth phase is the negative signal, the zero signal, the zero signal, the positive signal, the positive signal, the zero signal, the zero signal, and the negative signal, and the second driving signal in the first phase to the eighth phase is the zero signal, the positive signal, the negative signal, the zero signal, the zero signal, the negative signal, the positive signal, and the zero signal.

11. A projection device comprising an illumination system, a light valve, a projection lens, and an actuator device, wherein
the illumination system is configured to provide an illumination beam,
the light valve is located on a transmission path of the illumination beam, the light valve has an effective area, the effective area is configured to receive the illumination beam and is configured to convert the illumination beam into an image beam, the light valve comprises a plurality of micromirrors located on the effective area, and two central axes of the effective area are parallel to a first direction and a second direction,
the projection lens is located on a transmission path of the image beam and is configured to project the image beam out of the projection device, and
the actuator device is located on the transmission path of the image beam from the light valve and is disposed between the light valve and the projection lens or disposed within the projection lens, and the actuator device comprises a base, a frame, an optical element, at least two driving components, and a controller, wherein
the frame is disposed in the base,
the optical element is disposed in the frame, and two central axes of the optical element are parallel to the first direction and the second direction,
the at least two driving components are disposed between the base and the frame corresponding to the two central axes of the optical element, and the at least two driving components are configured to drive the frame and the optical element to swing with respect to the base with the two central axes as rotation axes; and
the controller is electrically connected to the at least two driving components and configured to drive the at least two driving components to make the optical element swing according to a swing mode,
wherein the swing mode at least comprises swinging of the optical element with respect to the base, so that an image beam from the optical element displaces toward a third direction, and a vector of the third direction is a difference between a vector of the first direction and a vector of the second direction.

12. The projection device as claimed in claim 11, wherein the swing mode comprises at least one of a first swing mode, a second swing mode, and a third swing mode, wherein the first swing mode further comprises making the image beam from the optical element to displace toward a direction opposite to the third direction, a fourth direction, and an opposite direction thereof, the second swing mode further comprises making the image beam from the optical element to displace toward the second direction and a direction opposite to the first direction, the third swing mode further comprises making the image beam from the optical element to displace toward the direction opposite to the third direction, the second direction, and an opposite direction thereof, and a vector of the fourth direction is a sum of the vector of the first direction and the vector of the second direction.

13. The projection device as claimed in claim 11, wherein the at least two driving components comprise at least one first driving component and at least one second driving component, the two central axes of the optical element comprise a first axis parallel to the second direction and a second axis parallel to the first direction, wherein:
the at least one first driving component is configured to make the optical element swing back and forth with respect to the base with the first axis as a rotation axis, and
the at least one second driving component is configured to make the optical element swing back and forth with respect to the base with the second axis as a rotation axis.

14. The projection device as claimed in claim 13, wherein the controller is configured to drive the at least two driving components by a plurality of driving signals,
wherein the plurality of driving signals comprise a first driving signal configured to drive the at least one first driving component and a second driving signal configured to drive the at least one second driving component,
wherein in each phase of each cycle, one of the first driving signal and the second driving signal is a zero signal, while the other is a positive signal or a negative signal.

15. The projection device as claimed in claim 14, wherein each of the cycles of the swing mode sequentially comprises a first phase, a second phase, a third phase, and a fourth phase,
wherein the swing mode comprises making the image beam from the optical element to displace toward the third direction, a fourth direction, a direction opposite to the third direction, and a direction opposite to the fourth direction in the first phase to the fourth phase respectively, and a vector of the fourth direction is a sum of the vector of the first direction and the vector of the second direction.

16. The projection device as claimed in claim 15, wherein the first driving signal in the first phase to the fourth phase is sequentially the zero signal, the positive signal, the zero signal, and the negative signal, the second driving signal in the first phase to the fourth phase is sequentially the positive signal, the zero signal, the negative signal, and the zero signal.

17. The projection device as claimed in claim 14, wherein each of the cycles of the swing mode sequentially comprises a first phase, a second phase, a third phase, and a fourth phase,
wherein the swing mode comprises making the image beam from the optical element to displace toward the third direction, the second direction, the third direction, and a direction opposite to the first direction in the first phase to the fourth phase respectively.

18. The projection device as claimed in claim 17, wherein the first driving signal in the first phase to the fourth phase is sequentially the zero signal, the zero signal, the positive signal, and the negative signal, the second driving signal in the first phase to the fourth phase is sequentially the positive signal, the negative signal, the zero signal, and the zero signal.

19. The projection device as claimed in claim 14, wherein each of the cycles of the swing mode sequentially comprises a first phase, a second phase, a third phase, a fourth phase, a fifth phase, a sixth phase, a seventh phase, and an eighth phase,
wherein the swing mode comprises making the image beam from the optical element to displace toward the third direction, the second direction, the third direction, a direction opposite to the third direction, a direction opposite to the second direction, and the direction opposite to the third direction in the second phase to the fourth phase and the sixth phase to the eighth phase respectively.

20. The projection device as claimed in claim 19, wherein the first driving signal in the first phase to the eighth phase is the negative signal, the zero signal, the zero signal, the positive signal, the positive signal, the zero signal, the zero signal, and the negative signal, the second driving signal in the first phase to the eighth phase is the zero signal, the positive signal, the negative signal, the zero signal, the zero signal, the negative signal, the positive signal, and the zero signal.
